(19) United States
(12) Patent Application Publication
(10) Pub. No.: US 2017/0243265 A1
(43) Pub. Date: Aug. 24, 2017

(54) Electronic Purchase and Charge Exemption System

(71) Applicants: Junsheng Li, Dalian (CN); Yinqiu Li, Dalian (CN)

(72) Inventors: Junsheng Li, Dalian (CN); Yinqiu Li, Dalian (CN)

(21) Appl. No.: 15/048,734

(22) Filed: Feb. 19, 2016

(51) Int. Cl. G06Q 30/06

(52) U.S. Cl. CPC G06Q 30/0601

(57) ABSTRACT

This invention is a system and method for allowing a purchaser to make attempts for charge exemption when buying merchandise or services via a shopping platform over a communication network so they do not have to commit to paying the full price of the selected merchandise or service.

A purchaser selects a certain merchandise or service at a client system. The client system transmits information about the selection to a server system. The server system computes whether the charge exemption is approved.

The purchaser is allowed to continue making attempts until either he/she is approved or he/she uses up the allowed number of attempts. However, even if the purchaser does not win, he/she is allowed to pay the full price and purchase the item. If any of the purchaser's attempts are successful, or if the purchaser chooses to pay the full price of the item, the item is purchased.

### BACKGROUND

Currently there are many electronic purchase systems in existence. These systems allow purchasers to select merchandise or services, pay for the item immediately, and have the item delivered immediately or in the future. Previously, an efficient system of storage, logistics and inventory composition were the major contributors to a successful electronic purchase system. It would be useful to have new and innovative ways to entice purchasers to use electronic purchase systems.

### SUMMARY

This invention relates to a system and method for allowing purchasers to make electronic purchases with a chance for a charge exemption. A charge exemption allows a purchaser to purchase goods or services by paying only a fraction of the full price. This system entices more users to use the system than would otherwise because a charge exemption is an exciting way to potentially acquire goods or services at a reduced price.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is an overview of the flow of an embodiment of the system or method.

FIG. 2 is a block diagram of an embodiment of the system, identifying the parts of the system.

FIG. 3 is a flow chart of an embodiment of the system, describing the portion associated with generating an order page.

FIG. 4 is a flow chart of an embodiment of the system, describing the portion associated with a user opting to pay the full purchase price.

FIG. 5 is a flow chart of an embodiment of the system, describing the portion associated with a user opting to apply for a charge exemption.

### DETAILED DESCRIPTION

Technical staff in this field may wish to apply this charge exemption technique to different contexts. Although the example embodiments illustrated and discussed here are made up of a server and client terminals based on the internet environment, it can also be applied to various kinds of communications channels. For example, LAN, WAN, point-to-point connections, etc. On the other hand, the server system can be formed with any combination of hardware or software capable of realizing this technology. The client system can be composed of any combination of hardware or software that is capable of interacting with the server system. Both the server and the client terminals can be combined to form an integrated system which may contain a mobile terminal system, a TV system, a game system, a single-chip computer system or other consumer products that can be used to materialize this technology.

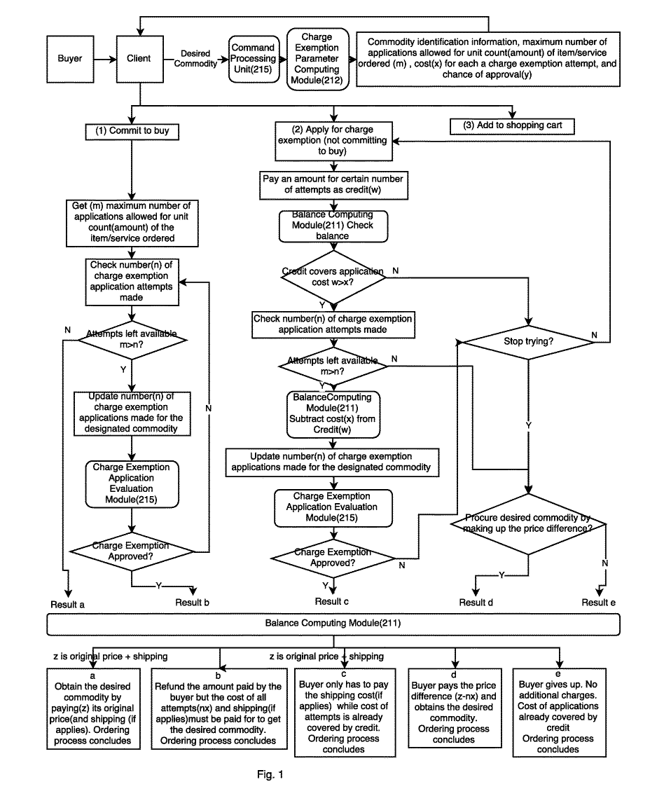

The embodiments of the invention may be implemented on a computer system that includes a central processing unit (CPU), a bus, system memory, read-only memory (ROM), and other components such as input or output devices, permanent storage devices, graphics processing units, and networking interfaces. Such a computer system may include various types of computer readable medium and/or interfaces for various types of computer readable medium. The components of such a computer system are electronic devices that automatically perform operations based on digital and/or analog input signals. Such a computer system may comprise the client unit or server unit described in FIGS. 1-5.

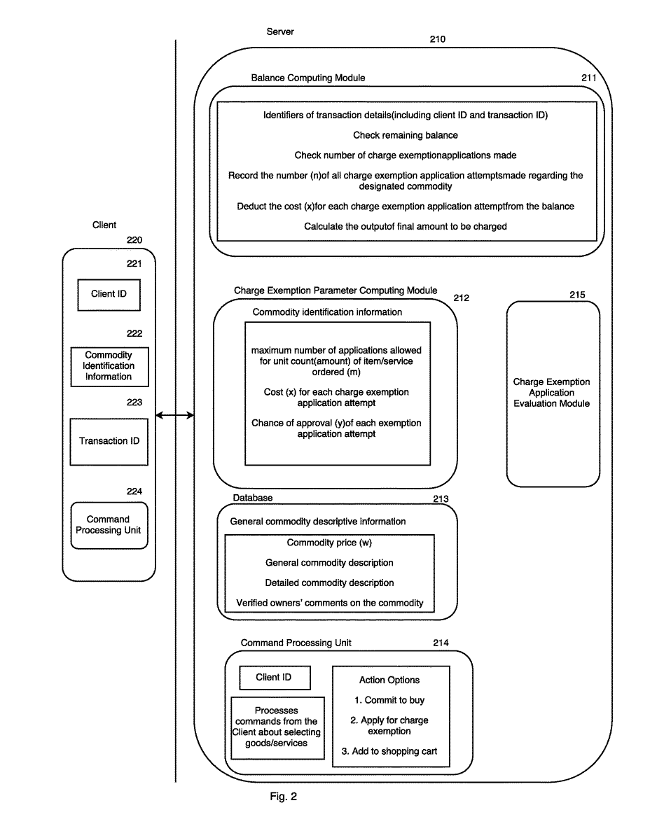

The particular embodiment illustrated in FIG. 2 supports “apply for charge exemption” through the internet. The example embodiment system is composed of a server unit 210 and a client unit 220. The server unit has three modules: a charge exemption parameter computing module 212, a charge exemption application evaluation module 215, and a balance computing module 211, as well as a database 213 and a command processing unit 214.

The client unit 220 has a client ID 221, commodity identification information 222, a transaction ID 223, and a command processing unit 224. The client unit 220 accesses the command processing unit 224 to send the client ID 221 and selected commodity identification information 222 (indicates which item or service a user has selected) to the server unit 210. The server unit 210 receives the information through the command processing unit 214 and accesses the charge exemption parameter computing module 212. The charge exemption parameter computing module 212 is responsible for computing the following parameters—chance of getting approval of each charge exemption application attempt of the selected item/service, the cost of each application and the maximum number of applications allowed per unit count of item/service ordered.

Charge exemption parameter computing module 212 computes the cost of each charge exemption application, the chance of approval for each charge exemption application, and the maximum number of applications allowed per unit count of item/service ordered. Server unit 210 retrieves the computed parameters from charge exemption parameter computing module 212. Server unit 210 combines the above parameters with the price and quantity available of the selected item/service and sends this information to the client unit 220. Server unit 210 accesses command processing unit 214 to instruct client unit 220 to display the above information along with a prompt with 3 choices: (1) customer pays full price for the item/service and purchases it, (2) customer applies for charge exemption, and (3) customer adds selected item/service to shopping cart.

The client unit 220 receives input from the customer and sends the command of the customer to the server unit 210. The server unit 210 processes the command with the command processing unit 214 and responds depending on the selected command.

If the selected command is “pay full price,” the server unit 210 will automatically instruct the charge exemption application evaluation module 215 to evaluate attempts of charge exemption application until either an application is approved or the maximum number of applications allowed per unit count of item/service ordered for the selected item/service has been reached. If charge exemption is approved, the balance computing module 211 will compute the final balance that the customer must pay; the price of the item/service will not be added to the balance but the cost of the applications will be added, as well as shipping costs if shipping is needed. If charge exemption is not approved after all the attempts have been used, the balance will be the price of the item/service and the shipping cost if shipping is needed. Finally, the purchasing process regarding the specific item/service concludes.

If the selected command is “apply for charge exemption,” the server unit 210 sends to client unit 220 instructions to display a prompt instructing the customer to make a payment for the cost of the applications. Each time the server unit 210 receives an application from the client unit 220, server unit 220 accesses the balance computing module 211 to check whether there is still enough credit to pay for the application. If the credit is enough to cover the cost of the application, the balance computing module 211 will deduct the cost of the application from the credit. Then the server unit 210 will access the Charge Exemption Application Evaluation Module 215 to evaluate whether the particular application is approved or not. If the application is approved the customer will have to make no more payment other than the shipping cost if shipping applies, and the total balance will be computed by the balance computing module 211. If the application is not approved, the customer can choose to make another application as long as there is still enough credit and the maximum number of applications allowed per unit count of item/service ordered for the current order is not reached. The customer can also choose to “pay the difference”, and pay an amount of money so that together with the payment for the cost of the spent applications the customer pays the amount of the full purchase price of the item/service and gets the item/service. If the customer chooses to give up at any time, the cost of the applications will not be refunded.

If the selected command is “add item/service to shopping cart,” the server unit 210 places it on record that the customer placed the selected item/service into the cart. The customer can add items/services to the cart at will and later choose from the above two actions for the batch of selected items/services or separately for each item/service.

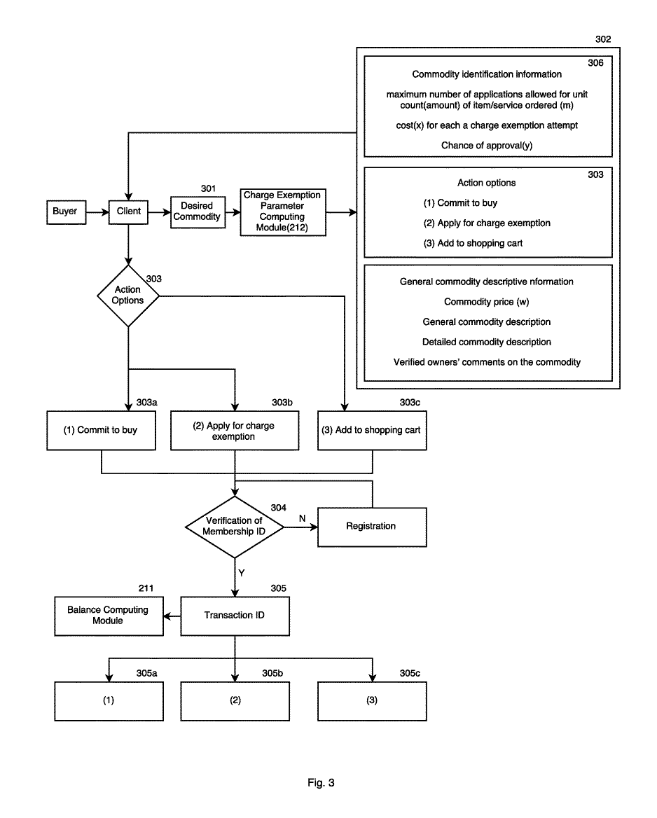

An example embodiment of generating an order web page is illustrated in FIG. 3. When a buyer requests to examine details of a desired commodity 301, a server will receive this request and generate a web page 302, which is transmitted to the client for display. Web page 302 contains general descriptive information of commodities (as the normal operation does), action options 303, which include “Commit to buy” 303a, “Apply for charge exemption” 303b, and “Add to shopping cart” 303c. Although there are 3 selectable action options 303, more options can be added or some of the existing options can be reduced from these action options 303. Web page 302 also contains commodity identification information 306. Commodity identification information 306 contains the following: the maximum number of opportunities to apply for charge exemption m, cost x for each attempt to obtain a charge exemption, and success rate y for each attempt. Although the maximum number of opportunities to apply for charge exemption m, cost x for each attempt to obtain a charge exemption, and success rate y for each attempt are contained in the commodity identification information 306 of this implementation example, evaluation of an application can be also realized through other means. The information regarding the specific commodity/service may be manipulated in many ways. For example, reorganize, increase or reduce the information shown in commodity identification information 306, or conceal any piece of such information. It has been recognized by the technical staff in this field that the same basic algorithm can also be implemented by using other methods.

The selection of an action option 303 determines how an order is completed. Once a user selects an action option 303, the system must verify membership information in order to complete the transaction. A separate sub-process, verification of membership ID 304 occurs after action option 303 is selected. Once membership is verified, transaction ID 305 is assigned to the transaction. The transaction then proceeds according the selected action option 303.

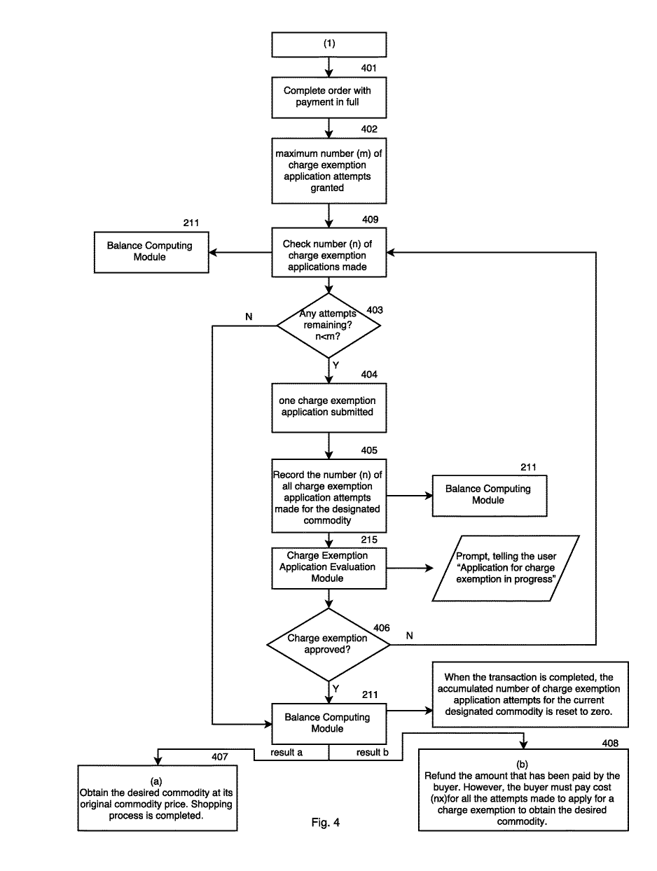

If the user selected “Commit to buy” 303a, the transaction continues as illustrated in FIG. 4. The process continues to sub-process 401, where the buyer completes the order with full payment, which follows the same procedures as those of a conventional shopping operation: start from payment, run through order processing, delivery, and end up with confirming receipt of items/services. The transaction then proceeds to sub-process 402, where upon completion of orders for designated commodities/services, m number of charge exemption application opportunities will be offered to the buyer automatically. The transaction proceeds to sub-process 409.

In sub-process 409, balance computing module 211 will check the total number of exemption application attempts the buyer has made and the transaction proceeds to sub-process 403.

In sub-process 403, before the buyer begins an attempt to apply for a charge exemption, the system checks if any charge exemption application attempts remain. If there are still more applications available for the buyer, sub-process 404 will proceed; otherwise, the operation will go to sub-process 407.

In sub-process 404, an attempt to apply for a charge exemption is made automatically on the buyer's behalf, and the transaction proceeds to sub-process 405.

In sub-process 405, the balance computing module 211 records and updates the number of exemption application attempts and counts up all the charge exemption application attempts the buyer has made for the particular transaction at hand, the cumulative sum of which is n. The result of n will be stored for computation of final (and additional) charge. The transaction proceeds to sub-process 406.

In sub-process 406, the charge exemption application evaluation module 215 outputs the result for the current exemption application attempt computed with the preset algorithm. If the result of output indicates that the buyer has won a charge exemption, the transaction proceeds to sub-process 408; otherwise, the transaction proceeds to sub-process 409.

In sub-process 407, the balance computing module 211 computes the final charge for the current transaction. The buyer who has run out of all the charge exemption application opportunities will obtain the desired commodities at their original commodity price. When the transaction is completed, the accumulated number of charge exemption application attempts for the current designated commodity will be reset to zero.

In sub-process 408, if a charge exemption application from a buyer is approved, the payment he/she has made for the designated item will be refunded to him/her. In order to obtain the desired commodity, he/she will only need to pay the cost nx for all the exemption application attempts he/she has made. When the transaction is completed, the accumulated number of charge exemption application attempts for the current designated commodity will be reset to zero. Although in this implementation example the maximum number of charge exemption opportunities allowable for a certain commodity is a fixed value, in practice, different buyers can be given different maximum numbers of charge exemption opportunities, depending upon the result of calculation.

Each action to apply for charge exemption can be regarded either as a single tentative action or as representing a number of tentative actions initiated through one single command. The procedures given in FIG. 4 are capable of combining some part of the procedures by means of batch processing. On the other hand, the procedures starting from Step 402 to the final step of the procedures in FIG. 4 can be completed by merging them into a one-key operation.

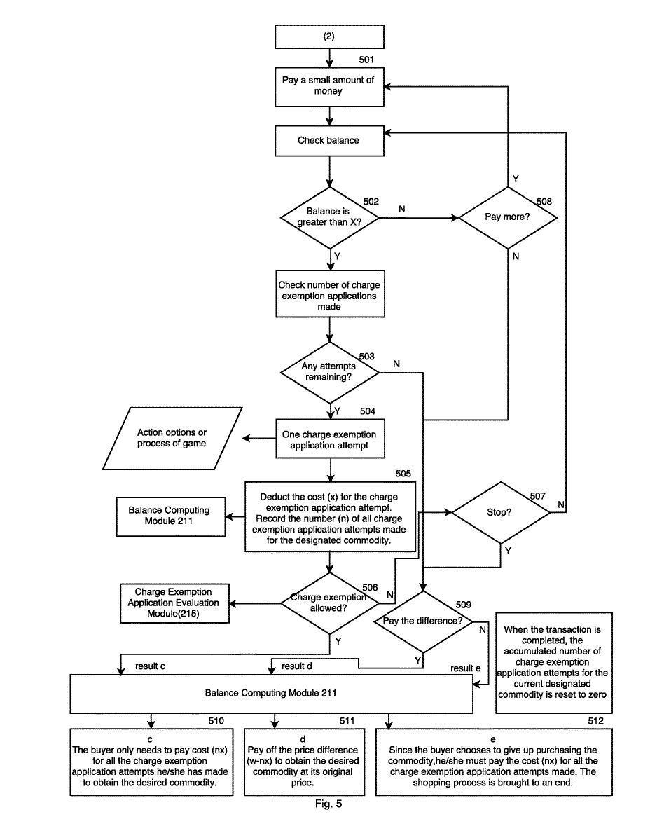

If the user selected “Apply for charge exemption” 303b, the transaction continues as illustrated in FIG. 5. In sub-process 501, the client sends the buyer's input to the server, and the buyer pays a small amount for the cost of exemption application attempts through cash payment (or credit payment).

The transaction then proceeds to sub-process 502, where the balance computing module 211 determines whether the current balance is adequate to pay for a charge exemption application attempt. Only when the balance is greater than the cost x needed to pay for the next attempt can the buyer proceed with the next application for an exemption in sub-process 503. If the balance is less than the cost x for making one more application attempt, the transaction proceeds to sub-process 508.

By checking the number of applications the buyer has made, the system can determine whether there are still opportunities available for the buyer to make more attempts for applying for an expected exemption. Sub-process 503 determines if a buyer has any charge exemption application attempts remaining. If the number of exemption application attempts so far made is less than m, i.e. there are still exemption application opportunities available, the transaction proceeds to sub-process 504; if the number of exemption application attempts made is equal to m, i.e. the exemption application opportunities allowed have run out, then the transaction proceeds to sub-process 509.

Sub-process 504 evaluates a charge exemption application attempt once it has been determined that a buyer can proceed the attempt. The charge exemption application evaluation module 215 receives the command of performing one charge exemption application evaluation for the current transaction, and determines in real-time whether the current exemption application is successful based on the commodity identification information, user ID and transaction ID at hand. The transaction then proceeds to sub-process 505.

Sub-process 505 will deduct the cost of the current attempt and increment the count of exemption application attempts initiated by the. The transaction then proceeds to sub-process 506.

Sub-process 506 outputs the result for the current exemption application attempt based on the preset algorithm. If the resulted output indicates that the application is approved, proceed to sub-process 510; otherwise, if the result indicates that the charge exemption application is not approved, proceed to sub-process 507.

Sub-process 507 asks the buyer if he or she wishes to stop the process. If the buyer indicates “no”, the system will proceed to check the balance with sub-process 502. If the buyer indicates “yes”, the system will proceed to sub-process 509.

In sub-process 508, two options are offered for the situation in which the buyer does not have adequate balance for continuing further exemption application attempts. If he/she chooses to stop the process, the transaction proceeds to sub-process 509; if he/she chooses to continue the process, proceed to sub-process 501.

In sub-process 509, two options are offered for buyers who have run out of their charge exemption application opportunities or have chosen to stop further charge exemption application attempts: pay the difference or give up. If he/she chooses to purchase the desired commodity through making up for the price difference, proceed to sub-process 511; if the buyer chooses to give up buying the desired commodity through making up for the price difference, proceed to sub-process 512.

In sub-process 510, the buyer has won a charge exemption and he/she will only need to pay the cost nx for the charge exemption application attempts he/she has made in exchange for the desired item/service, i.e. the number of application attempts made multiplied by the cost of each attempt, as well as any shipping fees.

In sub-process 511, the buyer who chooses to buy the desired item/service through making up for the price difference must pay off the price difference (w-nx), as well as any shipping fees, to obtain the desired item/service at its original purchase price.

In sub-process 512, the buyer has given up the choice to buy the item/service at its original price. The buyer still must pay the cost nx for all the charge exemption application attempts he/she has made. The buyer will get a final balance computed by the balance computing module 211. This will bring the shopping process to an end. When the transaction is completed, the accumulated number of charge exemption application attempts made for the designated item/service will be reset to zero.

Each action to apply for charge exemption can be regarded either as a single action or as a batch of tentative actions initiated through one single command. The procedures given in FIG. 5 are capable of combining some part of the procedures by means of batch processing.

Charge exemption application attempts can be achieved by clicking a certain area with the mouse, through a voice command, from a keyboard, by devices with movement/gesture perceptive functions, or by operating a remote controller. It can also be the result of a game.

The following implementation example will further illustrate the system and method described: a buyer requests to view the details of commodity A, he/she gets the “Identification Information of Commodity A”, and the maximum number of charge exemption application opportunities offered to him/her is 10. The cost of each exemption application attempt is 50 cents, the success rate for each charge exemption application attempt is 1/100, and the commodity price is 50 US dollars. The buyer chooses (1) to commit to buy, and completes the order by paying 50 US dollars in full, with his/her user ID having been verified and combined with the ID of the current transaction. The buyer gets 10 opportunities to apply for a charge exemption. In accordance with the procedure in FIG. 4, if none of the buyer's charge exemption applications are approved after he/she has used all of his/her 10 opportunities, the shopping process will come to an end. In accordance with result a, the buyer finally obtains commodity A by paying 50 US dollars. Suppose the 6th application is approved, the system will refund 50 US dollars already paid by the buyer in accordance with result b. However, the buyer needs to pay the cost for all 6 charge exemption application attempts the buyer has made, which means the buyer has to pay a total amount of 6×0.50, that is, 3 US dollars, in exchange for commodity A. If the buyer chooses to (2) apply for charge exemption, after his/her user ID has been verified and combined with the ID of the current transaction, he/she will only need to pay 5 US dollars or less, but no less than 50 cents, perhaps 3 US dollars, in advance. Assuming that the buyer pays 3 US dollars as credit, he/she will be given the opportunity to make 6 attempts to apply for a charge exemption. If an exemption is approved on his/her 4th attempt, he/she will have a credit of 1 US dollar, and will obtain commodity A, in accordance with result c. If none of the 6 attempts of the buyer get approved, and the buyer does not have sufficient credit left in the account to pay for another charge exemption application attempt, in accordance with sub-process 508, he/she can choose to give up any further attempt to apply for an exemption. As shown in sub-process 509, if the buyer chooses to buy commodity A by making up for the price difference, he/she will need to pay the price difference 50-6×0.50 in accordance with result d. In other words, he/she will have to pay off the remaining 47 US dollars and finally pay 50 US dollars in exchange for commodity A. If the buyer chooses to give up in sub-process 509, he/she will have paid 3 US dollars, in accordance with result e, and the process concludes without the buyer obtaining commodity A. No matter what action option the buyer chooses, in the context of the current transaction, the buyer will be allowed to apply for a charge exemption only when the following two conditions are simultaneously satisfied: the balance remaining in the current account is greater than or equal 0.50 US dollars, and the total number of charge exemption application attempts for this one unit count of commodity A so far made is less than 10. When the transaction is completed, the accumulated number of charge exemption application attempts made for the designated commodities will be reset to zero. And with that the buyer can begin a new order for commodity A or order other commodities.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

What is claimed is:

1. An electronic purchase and charge exemption system comprising:
a processor;
a client unit;
a server unit;
a computer readable storage media that comprises instructions stored in the computer readable storage media that are executable with the processor, the instructions comprising:
instructions for the client to display a list of items comprising goods or services;
instructions to transmit information about the selected item from the client to the server in response to an item selection command indicative of a user selecting an item from the list of goods or services;
instructions for the client to display a prompt listing the action commands “pay full price” and “apply for charge exemption” in response to the client receiving information about a selected item's price and available quantity;
instructions to transmit information about the selected command from the client to the server in response to an action selection command indicative of a user selecting an action from the prompt listing action commands;
instructions for the server to compute whether a charge exemption attempt is successful in response to receiving information about a selected “apply for charge exemption” command;
instructions to transmit from the server to the client the results of a charge exemption computation.

2. The electronic purchase and charge exemption system of claim 1, further comprising:
instructions to disallow further “apply for charge exemption” commands once a maximum number of allowed attempts has been reached;
instructions for the client to display a prompt listing the action command “pay the difference” in response to either a user selecting a “stop” action command or the maximum number of allowed attempts being reached;
instructions for the server to compute a final price for the selected item in response to receiving information about a selected “pay the difference” command.

3. The electronic purchase and charge exemption system of claim 1, further comprising:
instructions to charge a user for the cost of all “apply for charge exemption” attempts in response to the server receiving information about a selected “stop” action command.

4. A method of electronic purchase and charge exemption comprising:
displaying with a display device a list of items comprising goods or services;
in response to receipt from a selection device of an item selection command:
retrieving from a database and displaying with the display device information about the selected item's price and quantity available;
in response to receipt from the selection device of an action selection command:
computing with a computing device whether a charge exemption attempt is successful.
